(19) United States
(12) Patent Application Publication
(10) Pub. No.: US 2008/0247359 A1
(43) Pub. Date: Oct. 9, 2008

(54) MOBILE DEVICE HANDOFF CONTROLLER AND METHOD AND SYSTEM INCLUDING THE SAME

(75) Inventors: Henrik BENGTSSON, Lund (SE); Johan APELQVIST, Hjarup (SE); Per ASTRAND, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/736,018

(22) Filed: Apr. 17, 2007

Related U.S. Application Data
(60) Provisional application No. 60/909,961, filed on Apr. 4, 2007.

(51) Int. Cl. H04Q 7/38

(52) U.S. Cl. 370/331

(57) ABSTRACT

A hand-off controller for use in a system including an application server, the application server being connected to a mobile device via a first network connection to conduct an application session involving data communications between the application server and the mobile device. The hand-off controller is operatively coupled to the application server and configured to recognize that a surrogate device has connected to the application server via a second network connection; recognize that the surrogate device is intended to participate in the application session in the place of the mobile device; enable data communications directed to the mobile device from the application server, in relation to the application session, to be sent to the surrogate device; and enable data communications directed to the application server from the surrogate device, in relation to the application session, to be sent to the application server, whereby the surrogate device is able to continue the application session with the application server in place of the mobile device.

### RELATED APPLICATION DATA

The present application claims the benefit of U.S. Provisional Application Ser. No. 60/909,961, filed Apr. 4, 2007, the disclosure of which is herein incorporated by reference in its entirety.

### TECHNICAL FIELD OF THE INVENTION

The present invention relates generally to network systems, and more particularly to network applications in conjunction with one or more mobile devices.

### DESCRIPTION OF THE RELATED ART

Mobile devices such as mobile phones, electronic organizers, personal digital assistants, etc., have become commonplace in today's society. People have come to rely on their mobile devices to keep them in contact with work, friends, associates, etc. Moreover, mobile devices have become increasingly integrated allowing, for example, a given mobile device to possess many functions such as phone, data organizer, media player, email terminal, game player, etc. Furthermore, many mobile devices are functional as portable personal computers capable of carrying out conventional computer based applications, e.g., word processing, web browsing, spreadsheets, etc.

Mobile devices today are capable of connecting to a wide area network (WAN) such as a mobile network provider and/or the Internet, and carrying out any of a variety of different types of applications. For example, a user of a mobile device may connect to a network media server in order to download or stream media files such as music, video, ring tones, etc. Alternatively, the mobile device may connect to a network chat server that enables the user to send/receive text messages in relation to another user in the context of a chat session, instant messaging session, etc. Still further, the mobile device may connect to a network video that enables the user to conduct video over IP with one or more other users on the network.

A disadvantage associated with mobile devices is that the user interface (e.g., display, keypad, touchscreen, etc.) tends to be somewhat small. For example, a user may have difficulty making out details of an image on a small display. Similarly, a user may have difficulty manipulating the keys on a small keypad. In many cases, the keypad is limited, e.g., does not have keys corresponding to a complete QWERTY keyboard. Thus, a user is further inconvenienced in that it is difficult to input text easily.

In view of the aforementioned shortcomings associated with mobile devices, there is a strong need in the art for an apparatus and method for enabling the user of a mobile device to carry on the functions of the mobile device without the inconvenience of a small and/or limited user interface.

### SUMMARY

In accordance with one aspect of the invention, a hand-off controller for use in a system including an application server is provided. The application server is connected to a mobile device via a first network connection to conduct an application session involving data communications between the application server and the mobile device, and the hand-off controller is operatively coupled to the application server. The hand-off controller recognizes that a surrogate device has connected to the application server via a second network connection and recognizes that the surrogate device is intended to participate in the application session in the place of the mobile device. The hand-off controller enables data communications directed to the mobile device from the application server, in relation to the application session, to be sent to the surrogate device, and enables data communications directed to the application server from the surrogate device, in relation to the application session, to be sent to the application server whereby the surrogate device is able to continue the application session with the application server in place of the mobile device.

In accordance with another aspect, the hand-off controller is included within the application server.

According to yet another aspect, the surrogate device comprises at least one of a keyboard or display that is larger than a corresponding keyboard or display of the mobile device, and the hand-off controller enables a user to utilize the at least one of a keyboard or display of the surrogate device in place of the corresponding keyboard or display of the mobile device in continuing the application session.

In accordance with another embodiment, the hand-off controller enables the data communications directed to the mobile device from the application server, in relation to the application session, to be sent to the surrogate device via the second network connection; and enables the data communications directed to the application server from the surrogate device, in relation to the application session, to be sent to the application server via the second network connection.

According to still another aspect, the hand-off controller comprises a look up table that associates the first network connection and the second network connection with the application session.

In accordance with yet another aspect, the data communications sent from the application server to the surrogate device are copied to the mobile device.

According to another aspect of the invention, the hand-off controller requires user authorization prior to enabling the surrogate device to continue the application session.

With still another aspect, the application server is connected to a third party device via a third network connection as part of the application session, the application session involving data communications between the mobile device and the third party device via the application server over the first network connection and the third network connection. The hand-off controller is configured to enable data communications directed to the mobile device from the third party device as received by the application server via the third network connection, in relation to the application session, to be sent to the surrogate device via the second network connection. The hand-off controller is configured to enable data communications directed to the third party device from the surrogate device as received by the application server via the second network connection, in relation to the application session, to be sent to the third party device via the third network connection. The surrogate device is able to continue the application session with the third party device in place of the mobile device.

According to yet another aspect, the application session comprises a chat session.

In accordance with another aspect, the application session comprises video over internet.

In accordance with still another aspect, the hand-off controller comprises a look up table that associates the first network connection, second network connection, and third network connection with the application session.

According to another aspect, the data communications sent from the third party device to the surrogate device are copied to the mobile device.

According to still another aspect, the hand-off controller requires user authorization prior to enabling the surrogate device to continue the application session.

In accordance with another aspect, a method for handing off communications in a system including an application server is provided. The application server is connected to a mobile device via a first network connection to conduct an application session involving data communications between the application server and the mobile device. The method recognizes that a surrogate device has connected to the application server via a second network connection and further recognizes that the surrogate device is intended to participate in the application session in the place of the mobile device. In addition, the method enables data communications directed to the mobile device from the application server, in relation to the application session, to be sent to the surrogate device, and enables data communications directed to the application server from the surrogate device, in relation to the application session, to be sent to the application server. The surrogate device is able to continue the application session with the application server in place of the mobile device.

In accordance with yet another aspect, the method is carried out within the application server.

According to another aspect, the method includes the surrogate device comprising at least one of a keyboard or display that is larger than a corresponding keyboard or display of the mobile device, and the method is carried out to enable a user to utilize the at least one of a keyboard or display of the surrogate device in place of the corresponding keyboard or display of the mobile device in continuing the application session.

In accordance with yet another aspect, the data communications directed to the mobile device from the application server, in relation to the application session, are sent to the surrogate device via the second network connection; and the data communications directed to the application server from the surrogate device, in relation to the application session, are sent to the application server via the second network connection.

With still another aspect, a look up table associates the first network connection and the second network connection with the application session.

With yet another aspect, the data communications sent from the application server to the surrogate device are copied to the mobile device.

In still another aspect, the method requires user authorization prior to enabling the surrogate device to continue the application session.

In accordance with another aspect, the application server is connected to a third party device via a third network connection as part of the application session. The application session involves data communications between the mobile device and the third party device via the application server over the first network connection and the third network connection. The method enables data communications directed to the mobile device from the third party device as received by the application server via the third network connection, in relation to the application session, to be sent to the surrogate device via the second network connection. In addition, the method enables data communications directed to the third party device from the surrogate device as received by the application server via the second network connection, in relation to the application session, to be sent to the third party device via the third network connection. The surrogate device is able to continue the application session with the third party device in place of the mobile device.

According to another aspect, the application session comprises a chat session.

According to yet another aspect, the application session comprises video over internet.

In still another aspect, the application session comprises voice over internet.

In accordance with yet still another aspect, a look up table associates the first network connection, second network connection, and third network connection with the application session.

According to another aspect, the data communications sent from the third party device to the surrogate device are copied to the mobile device.

According to yet another aspect, the method requires user authorization prior to enabling the surrogate device to continue the application session.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a system diagram of a handoff controller embodied in one or more network servers in accordance with one embodiment of the present invention;

FIG. 2 is a system diagram of a handoff controller embodied in one or more network servers in accordance with another embodiment of the present invention;

FIG. 3 is a schematic diagram representing a chat session before and after a session handoff from a mobile device to a surrogate device in accordance with an embodiment of the present invention;

FIGS. 4 and 5 represent an exemplary lookup table included in a handoff controller before and after the handoff in accordance with an embodiment of the present invention;

FIG. 6 is a flowchart describing operation of a user mobile device from which a session may be handed off in accordance with an embodiment of the present invention;

FIG. 7 is a schematic diagram representing a video over IP session before and after a session handoff from a mobile device to a surrogate device in accordance with an embodiment of the present invention;

FIG. 8 is a flowchart describing operation of a network server and handoff controller in relation to performing a session handoff in accordance with an embodiment of the invention;

FIG. 9 is a flowchart describing operation of a surrogate device to which a session may be handed to in accordance with an embodiment of the present invention;

FIG. 10 is a block diagram of a network server incorporating a handoff controller in accordance with an embodiment of the present invention;

FIG. 11 is a schematic diagram representing a music server session before and after a session handoff from a mobile device to a surrogate device in accordance with an embodiment of the present invention; and

FIG. 12 is an exemplary lookup table included in a handoff controller before and after the handoff in accordance with another embodiment of the present invention.

### DETAILED DESCRIPTION OF EMBODIMENTS

The present invention will now be described with reference to the drawings, in which like reference numerals are used to refer to like elements throughout.

As described herein, the present invention enables an application session involving a mobile device within a network to be handed off to a surrogate device having a more suitable user interface. In this manner, a user of a mobile device whom is engaging in a chat session with another network device is able to transfer the same chat session to a surrogate device such as a personal computer. This enables the user to continue the same chat session from the personal computer with the benefit of a larger display and/or keyboard as will be appreciated.

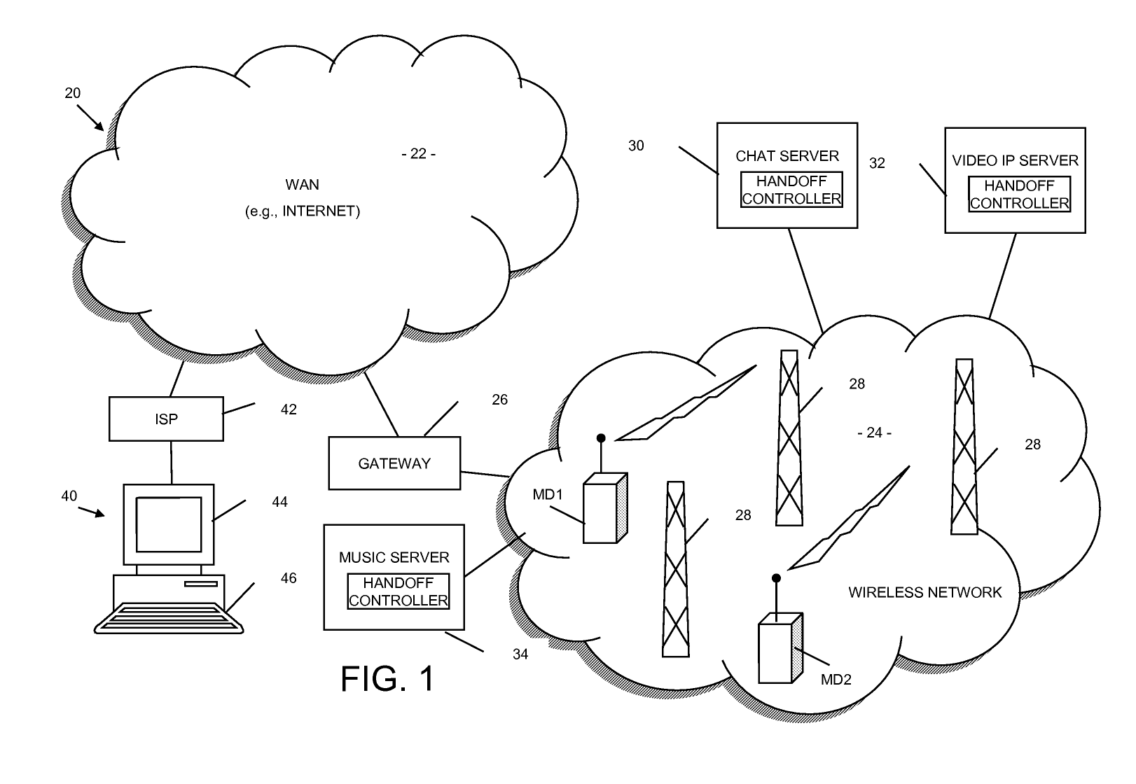

Referring initially to FIG. 1, an exemplary network system 20 in which the present invention may be implemented is shown. In the exemplary embodiment, the network system 20 may include one or more wide area networks (WANs) such as the Internet (or World-Wide-Web) 22 and a wireless network 24. As is shown in FIG. 1, the wireless network 24 may be linked to the Internet 22 via a gateway 26 or the like.

FIG. 1 illustrates how the wireless network 24 may include one or more mobile devices MD1, MD2, etc. In the exemplary embodiment, the mobile devices MD1 and MD2 may be mobile phones having multifunction capabilities including, for example, media player, web browser, data organizer, portable computing, etc., as are known. According to another embodiment, the mobile devices MD1 and MD2 may be some other type of device without departing from the scope of the invention. The mobile devices MD1 and MD2 may communicate with one another within the wireless network 24, for example via a system of cellular towers 28 or satellites as found in many conventional wireless networks such as those available through Verizon, Alltel, Cingular, T-Mobile, etc. Moreover, the mobile devices MD1 and MD2 may communicate with mobile devices in other wireless networks, other phones via a conventional PTSN, etc., via a corresponding gateway (not shown), as is known. Still further, the mobile devices MD1 and MD2 may communicate with devices on the Internet 22 via the gateway 26, as is also known.

In FIG. 1, the wireless network 24 includes one or more network servers for providing different applications in relation to the mobile devices MD1 and MD2. For example, chat server 30 allows for mobile devices such as MD1 and MD2 to carry out text messaging, chat sessions, instant messaging (IM) sessions, etc. with each other, other mobile devices, or other devices within the network system 20. Video over IP server 32 enables the mobile devices MD1 and MD2 to engage in video sessions such as video telephony with each other or other devices within the network system 20. Similarly, music server 34 enables the mobile devices to download or stream music and/or video from the server 34 to the mobile device. It will be appreciated that the particular types of servers described herein are merely exemplary of the different types of applications with which the present invention may be utilized. The principles described herein may be applied to other types of applications (e.g., essentially any application involving IP communication, including, for example, voice communications) without departing from the scope of the invention.

In the exemplary embodiment, each of the servers 30, 32, 34 includes its own handoff controller. Each handoff controller, as described in more detail below, controls handoff operations which enables application sessions in which a mobile device is engaged to be handed off to other network devices such as a personal computers, etc. This enables users of mobile devices to continue their particular application sessions via other network devices that may possess a more convenient user interface, environment, etc. Of course, it will be appreciated that the handoff controllers may be part of the respective servers themselves, or exist separately as devices within the network. Moreover, while each server is shown to include its own handoff controller, it will be appreciated that a single handoff controller may control handoff operations with respect to a variety of applications and/or application servers.

In the exemplary embodiment, the system 20 in FIG. 1 includes a personal computer 40 coupled to the Internet 22 via an Internet service provider (ISP) 42. The personal computer 40 includes a large display 44 and large keyboard 46. For purposes of illustration, it is assumed that the user of mobile device MD1 has access to personal computer 40 in his/her home or elsewhere. As a particular example, the user of MD1 may connect to the chat server 30 using conventional techniques in order to engage in a chat session with another device, such as MD2. During the chat session, the user of MD1 keys chat text into MD1 via its keyboard or the like. MD1 transmits the inputted text to MD2 via the chat server 30. In turn, the user of MD2 inputs text into MD2, which is then sent to MD1 via the chat server 30. In this manner, the users of MD1 and MD2 may engage in a chat session.

During such chat session, the user of MD1 may desire to transfer the chat session to his/her personal computer 40 in order to carry out the chat session with the benefit of a larger display 44 and/or keyboard 46. Using conventional techniques, such chat session could not simply be handed off or transferred to the personal computer 40. Instead, the user of MD1 must close the chat session with MD2. The user of MD1 must then establish a new chat session with MD2 using the personal computer 40 via the chat server 30. Of course, such steps are inconvenient to the user, require time to implement, and can destroy the “flow” of the chat session. Similarly, in the case of other types of applications (e.g., music server, video over IP server, etc.), the particular application session involving MD1 must be closed and a new application session started using the personal computer 40.

In accordance with the present invention, it is not necessary for the chat session between MD1 and MD2 be closed and then reopened using the personal computer 40. Instead, the handoff controller in accordance with the present invention enables the personal computer 40 to serve as a surrogate device for MD1 in the same application session. Simply stated, the handoff controller allows the personal computer 40 (or other surrogate device) to “step into the shoes” of MD1 within the same chat session. The user can then continue on with the chat session with MD2 using the larger display 44 and keyboard 46, for example.

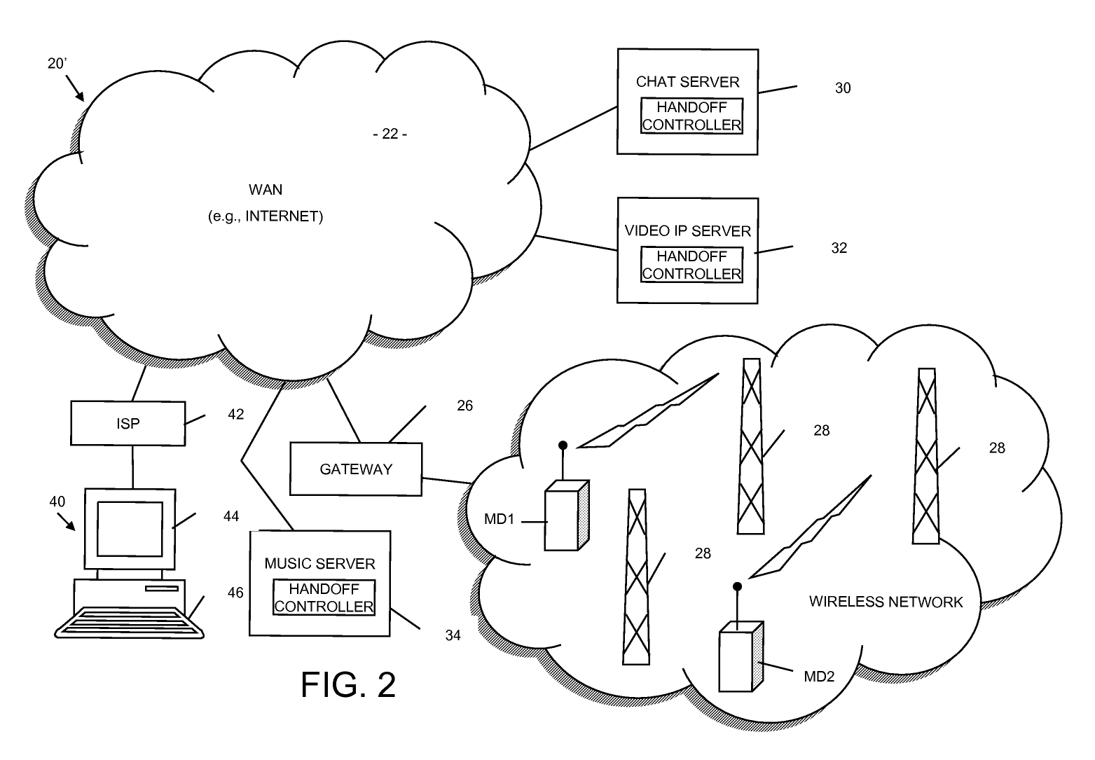

Referring briefly to FIG. 2, an alternate embodiment of the system 20 in FIG. 1 is designated 20′. In this embodiment, the chat server 30, video over IP server 32 and music server 34 are coupled to the Internet 22 rather than the wireless network 24. It will be appreciated that the respective server(s) and handoff controller(s) discussed herein can be connected within the system via the Internet 22, the wireless network 24, or any other network within the system 20 without departing from the scope of the invention. Provided the respective server(s) and/or handoff controller(s) have a known network address, the devices may be located virtually anywhere within the system 20 as will be appreciated.

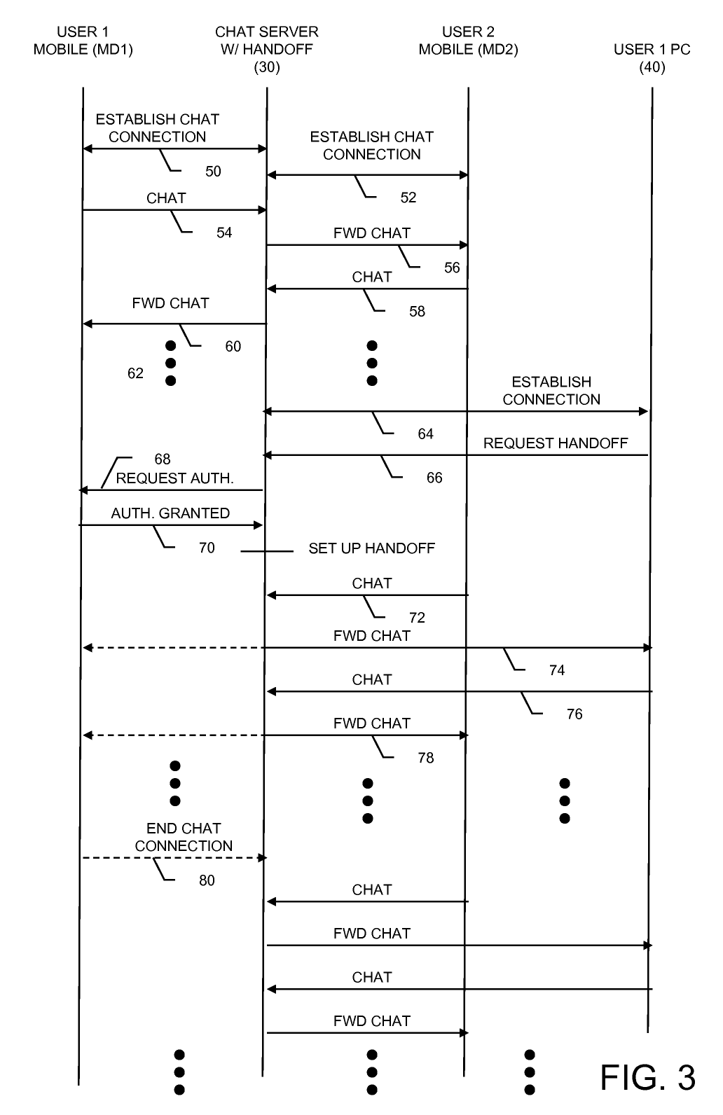

FIG. 3 graphically represents a chat session between MD1 and MD2 prior to and subsequent a handoff in accordance with the present invention. As illustrated, MD1 at 50 establishes a network chat connection with the chat server 30 using, for example, conventional TCP/IP techniques. Similarly, MD2 at 52 establishes a network chat connection with the chat server 30. Using conventional techniques, the chat server 30 establishes a chat session between MD1 and MD2 via the respective connections (e.g., as a result of MD1 indicating a desire to chat with MD2). At 54, the user of MD1 inputs chat text via the keypad of MD1 and the chat text is transmitted to the chat server 30.

Preferably, the chat text is transmitted in digital data packets which identify the source (e.g., MD1) and destination (e.g., MD2), and the chat server 30 delivers the chat text accordingly. Alternatively, the data packets include information on the particular chat session involved and based on the device from whom the chat text was received the chat server 30 correlates to which device the chat text is to be delivered to. The particular protocol for identifying and handling data traffic during such chat session applications may be any conventional protocol, and therefore further detail has been omitted for sake of brevity.

The chat server at 56 forwards the chat text received from MD1 at 54 to the intended recipient MD2. Similarly, the user of MD2 may respond with text at 58 by inserting such text via a keypad or the like and transmitting the chat text to the server 30. The chat server 30 in turn forwards the chat text to MD1 at 60. Such chat may continue back and forth as is conventional as represented at 62.

Suppose now that the user of MD1 would like to continue the same chat session with MD2, but would instead like to input and read text via the personal computer 40. In accordance with one embodiment of the invention, the user is able to proceed as follows. Beginning at 64, the user prompts the personal computer 40 to establish a network chat connection with the chat server 30. This can be a simple case of the user connecting to the chat server 30 via a conventional web browser. For example, the network address of the chat server 30 may be www.chatserver.com. In order to notify the chat server 30 as to which particular device the personal computer 40 wishes to serve as surrogate for, the personal computer 40 provides identification information. As a particular example, suppose MD1 is a mobile phone identifiable in the network system 20 by its mobile phone number (e.g., MD1phonenumber). Thus, at 66 the personal computer 40 may indicate that it requests that the chat session with MD2 be handed off by identifying MD1 via its phone number. In another embodiment, the personal computer 40 may connect to the chat server 30 and identify the device for which it wishes to be surrogate simply by entering www.chatserver.com/MD1phonenumber into the web browser address bar. Alternatively, the personal computer 40 may connect using some other network identifier (e.g., MAC address, etc.) identifying MD1 as the device for which personal computer 40 desires to serve as surrogate.

The handoff controller within the chat server 30 recognizes that the personal computer 40 has connected to the server for purposes of serving as a surrogate for MD1 based, for example, on the personal computer 40 navigating specifically to www.chatserver.com/MD1phonenumber. In an embodiment in which the handoff controller is separate from the chat server 30, the chat server 30 can notify the handoff controller of such event via conventional network communications. The handoff controller, upon recognizing that the personal computer 40 wishes to serve as surrogate for MD1 in the chat session with MD2, prompts the chat server 30 to transmit a request for authorization to hand off as represented at 68. This may be in the form of a text message sent to MD1 indicating that another device is requesting that the current session be handed off, and requesting that the user of MD1 either confirm or deny authorization (e.g., by entering “yes” or “no”, by entering or not entering a secret PIN, etc.). By requesting authorization, this avoids the possibility of an unintended device “hijacking” the chat session from MD1. If authorization is denied, MD1 transmits such denial to the chat server 30 that in turn terminates connection with the personal computer 40. The chat session between MD1 and MD2 may then proceed as before.

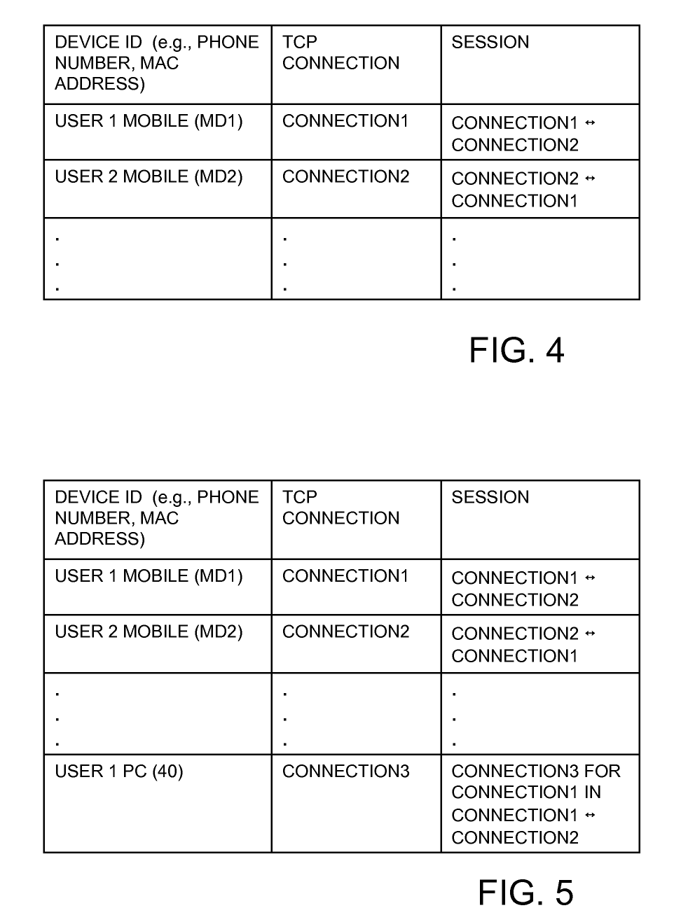

Provided authorization is granted as represented at 70, the chat server 30 in conjunction with the handoff controller establishes the hand off. Referring to FIG. 4, shown is a look-up table maintained by the handoff controller (alone or in conjunction with the chat server itself) prior to the hand off. The look-up table includes entries representing the device identification, network connection and session for each connection in the chat server. Thus, once MD1 has connected to the chat server 30 via network Connection 1 and MD2 has connected to the chat server 30 via network Connection 2, entries for the respective devices are entered in the look-up table. Moreover, session information identifying the particular chat session in which the devices are involved is also stored in the table. Accordingly, the entry for MD1 shows that it is connected to the server 30 via Connection 1 and is engaged in a chat session with MD2 by virtue of the session defined by Connection 1⇄Connection 2 (identifying the corresponding connections between the chat server 30 and the respective devices involved in the chat session). Similarly, the entry for MD2 shows that it is connected to the chat server 30 via Connection 2 and is engaged in a chat session with MD1 by virtue of the same session defined by Connection 1⇄Connection 2.

FIG. 5 represents the contents of the look-up table of FIG. 4 following the authorization of the handoff at 70 in FIG. 3. Specifically, the handoff controller adds an entry to the look-up table corresponding to the personal computer 40. The entry includes the network connection (i.e., Connection 3) by which the personal computer 40 is connected to the chat server 30. In addition, the entry identifies in the session information the particular session in which the personal computer wishes to serve as surrogate. Thus, for example, the look-up table identifies Connection 3 for Connection 1 in Connection 1⇄Connection 2.

The information included in the look-up table is made available to the chat server 30 by the handoff controller. By virtue of the entry in the look-up table for personal computer 40, the chat server 30 upon receiving chat text from MD2 via Connection 2 intended for MD1 knows to redirect the received chat text to the personal computer 40 via Connection 3 as represented at 72 and 74. Similarly, the chat server 30 upon receiving chat text from the personal computer 40 via Connection 3 knows to direct the text to MD2 via Connection 2 as represented at 76 and 78. In this manner, the personal computer 40 serves as a surrogate device for MD1 within the same chat session previously established between MD1 and MD2. As with all the embodiments discussed herein, it is assumed that the surrogate device such as the personal computer 40 is running corresponding or compatible application software (e.g., chat software) so as to be able to continue in place of MD1.

It is noted at 74 in FIG. 3 that according to one embodiment of the invention, chat text from MD2 which is redirected to surrogate personal computer 40 may also be mirrored or copied to MD1 as represented in dotted line. In such case, Connection 1 between the chat server 30 and MD1 is maintained after the handoff and the chat server 30 simply copies the text sent to the personal computer 40 from MD2 and sends the text to MD1 as well. Similarly, as represented in dotted line at 78 the chat server 30 copies the same text sent by the personal computer 40 to MD2, and sends the text to MD1 as well. In this manner, MD1 can be used to continue to track the chat session. At 80, MD1 may choose to terminate its connection with the chat server 30 and the chat session continues between MD2 and the personal computer 40. This may be as a result of an express request for termination provided by MD1. Alternatively, this may be as a result of a time-out period, etc. In still another embodiment, the handoff controller may be configured to terminate the connection between MD1 and the chat server 30 automatically following the establishment of the handoff. The look-up table in FIG. 5 may then be updated by removing the entry corresponding to MD1. The session identification information may then be updated to reflect only Connections 2 and 3 between the chat server 30, MD2 and personal computer 40. Alternatively, the same session identification information may be maintained in the look-up table since it is known that Connection 3 stands in place of Connection 1 as indicated by the entry for the personal computer 40. As noted in 82-88 in FIG. 3, the user of MD1 may then continue to enjoy participating in the chat session with MD2 via the personal computer 40.

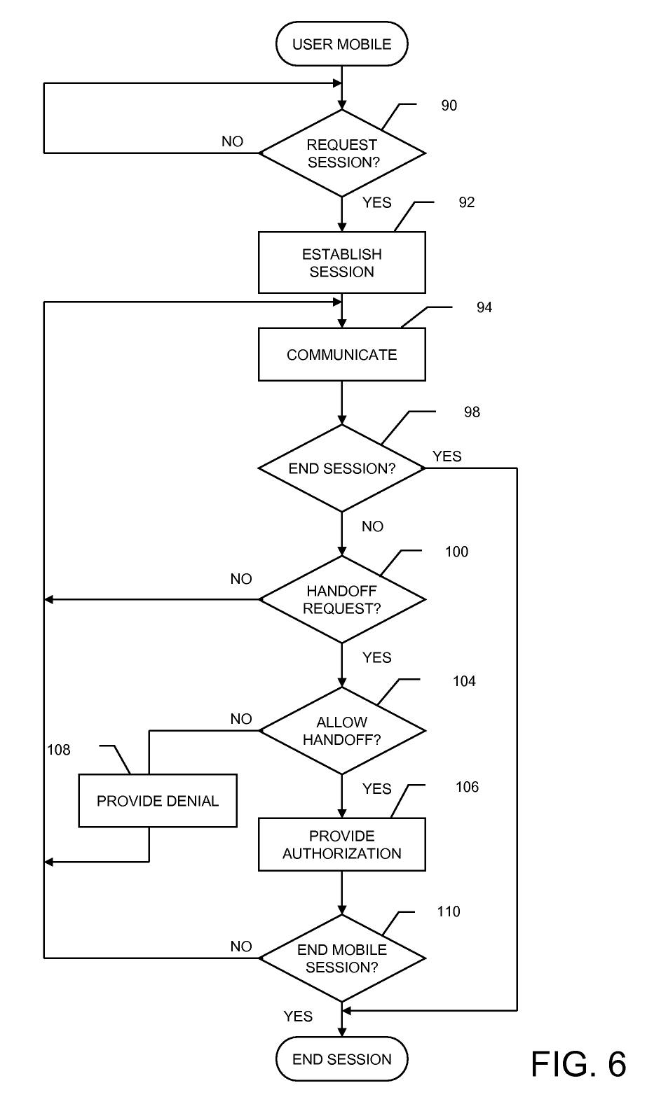

FIG. 6 is flowchart suitable for programming operation of a mobile device such as MD1. It is assumed that the user wishes to establish an application session with the chat server 30, video over IP server 34, etc. It is further assumed that the user will subsequently desire to hand the session off to a surrogate device such as the personal computer 40. Beginning in step 90, it is determined whether the user is requesting that an application session be established via input on a keypad, menu screen, etc. For example, the user may request a video over IP session via server 32 with another device MD2. In such case, MD1 and MD2 each include a video camera and microphone for capturing video and audio and transmitting the same to the other device via the video over IP server 32. Similarly, each includes a media player function to reproduce the audio and video received from the other device. If the user does not request a session, MD1 continues to loop around step 90.

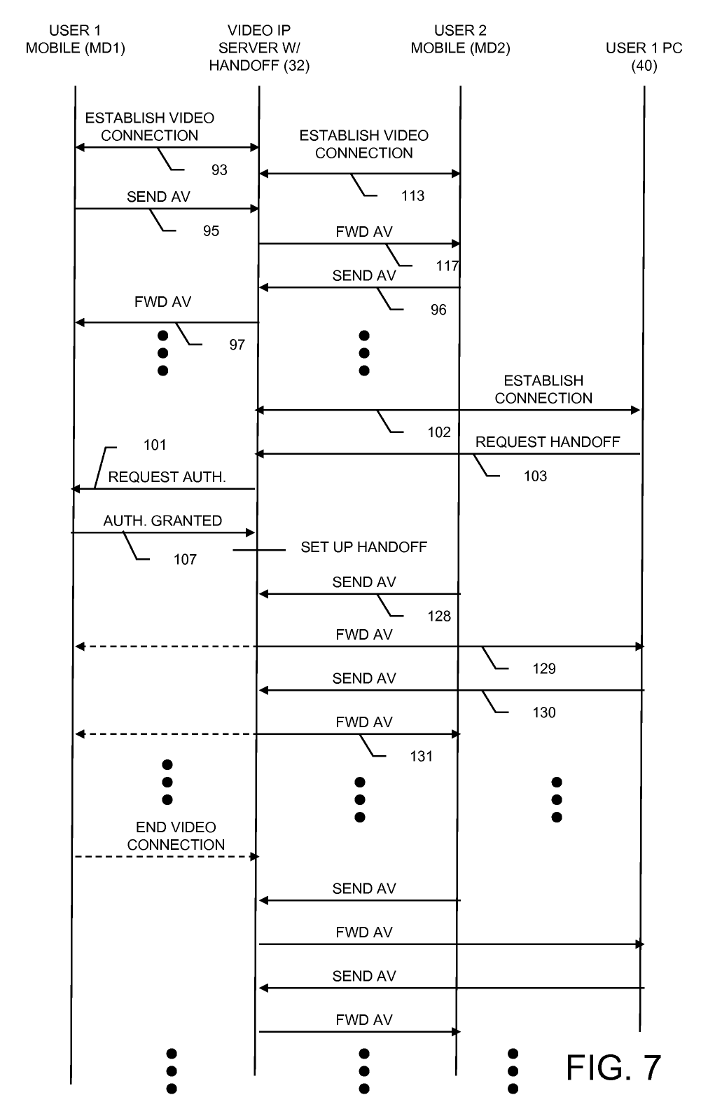

If the user does request an application session as determined in step 90, control proceeds to step 92 in which MD1 establishes a video over IP connection with the server 32 using conventional techniques (e.g., 93 in FIG. 7). Next, in step 94 MD1 begins to communicate with MD2 via the server 32 again using conventional techniques (95-97 in FIG. 7). In step 98, MD1 determines whether the user has requested that the session end. For example, the user may press an end session key on the keypad. If yes in step 96, MD1 ends the session via the server 32. If no in step 98, MD1 proceeds to step 100 in MD1 determines whether a handoff authorization request has been received from the server 32 (101 in FIG. 7). For example, the user of MD1 may use the personal computer 40 to connect to the server 32 (102 in FIG. 7) as in the above-described embodiment in relation to a chat session. The personal computer 40 requests a handoff again by identifying MD1 as the device for which the personal computer 40 wishes to serve as surrogate (103 in FIG. 7).

If a request for handoff operation has not been received as identified in step 100, MD1 returns to step 94. If a request for handoff authorization has been received as identified in step 100, the request is displayed on a display included in MD1, for example. The user of MD1 is thus prompted as to whether to allow the handoff as represented in step 104. If yes, the user of MD1 provides authorization in step 106 similar as discussed above in the example involving a chat session. Such authorization may be by simply entering a “yes” command and/or by entering a secret PIN that is communicated to the server 32 (107 in FIG. 7). If the user of MD1 does not wish to permit handoff of the video over IP session, for example due to an unauthorized device attempting to serve as surrogate, the user may deny authorization as represented in step 108. For example, the user may simply enter a “no” response that is sent to the server 32. MD1 then returns to step 94 and continues the session.

Following step 106, MD1 in step 110 checks whether the user has requested that the video over IP session be terminated. If no, control returns to step 94. If yes, MD1 ends the session using conventional techniques.

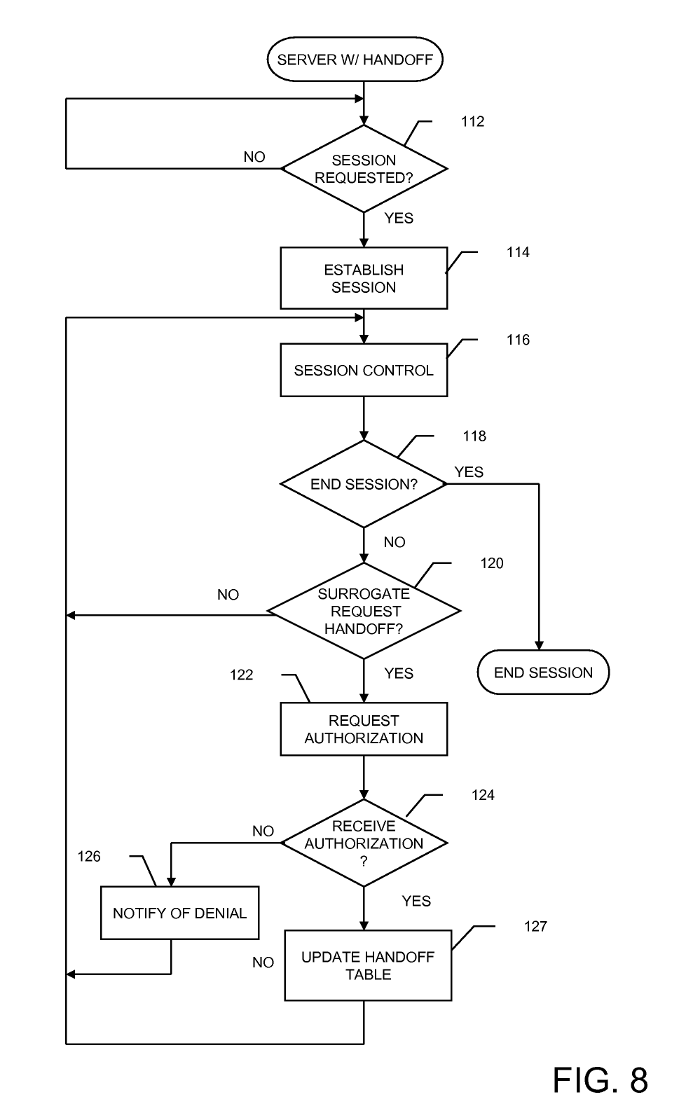

FIG. 8 is a flowchart suitable for programming operation of the application server (e.g., 30, 32 or 34) with handoff control in accordance with the present invention. In step 112, the server 32 in the present example determines if a video over IP session has been requested (e.g., as a result of MD1 and MD2 connecting to the server 32 and requesting a session as in 93 and 113 of FIG. 7). If no, the server 32 continues to loop around step 1 12. If yes in step 112, the server 32 proceeds to step 114 in which the server 32 establishes the session. In such case in addition to establishing the session as conventional, the handoff controller within the server 32 populates a look up table such as that shown in FIG. 4 to include MD1, MD2, their respective connections to the server 32, and the particular session in which they are involved. The server 32 then proceeds to step 116 in which the server 32 carries out conventional control of the session and MD1 and MD2 communicate with each other via video and audio data (95-97 and 117 in FIG. 7). In step 118, the server 32 determines if either of the devices MD1 or MD2 has requested that the session be ended. If yes, the server 32 ends the session using conventional techniques. If not, the server 32 proceeds to step 120.

In step 120, the server 32 determines if a surrogate device such as personal computer 40 is requesting a handoff with respect to MD1 (102 and 103 in FIG. 7). If no, the server 32 returns to step 116 and continues the session. If yes in step 120, the server 32 proceeds to step 122 in which the server 32 requests authorization from MD1 as to whether the handoff is to be permitted (101 in FIG. 7). The server 32 determines in following step 124 whether MD1 has granted or denied authorization for the handoff (107 in FIG. 7). If no in step 124, the server 32 notifies the surrogate device of the refusal as represented in step 126. Thereafter, control returns to step 11 6.

If authorization for handoff is provided from MD1 (107 in FIG. 7) in step 124, the handoff controller within the server 32 updates the handoff lookup table in step 127 as again exemplified in FIG. 5. Specifically, the surrogate device (personal computer 40) is added in the table together with its corresponding connection to the server 32. In addition, the handoff controller updates the session information in the lookup table in step 127 to indicate that the surrogate device now stands in for MD1 with respect to continuing the session. Following such handoff, session communications received from MD2 via the existing connection involving the session with MD1 are forwarded by the server 32 to the surrogate device personal computer 40 via the connection established between the server 32 and the personal computer 40 (128 and 129 in FIG. 7). Similarly, session communications received by the server 32 from the personal computer 40 are forwarded to MD2 (130 and 131 in FIG. 7) via the same connection originally established for the session involving MD1. Following step 127, the server 32 returns to step 116.

As will be appreciated, once a surrogate device such as the personal computer 40 takes over a session in place of MD1, another surrogate device my subsequently request authorization to step in for the previous surrogate device. For example, a different personal computer can connect to the server 32 and request a handoff on behalf of personal computer 40. Alternatively, MD1 may request to step back in to the session in place of personal computer 40. Still further, another device may request to serve as surrogate for MD2. Any and all of these alternatives are possible simply by virtue of the handoff controller maintaining the lookup table indicating the relevant sessions, session connections and device identities. The server 32 can therefore be made aware of whether and when communications for a particular device in an existing session are intended to be provided with respect to a surrogate device within the existing session.

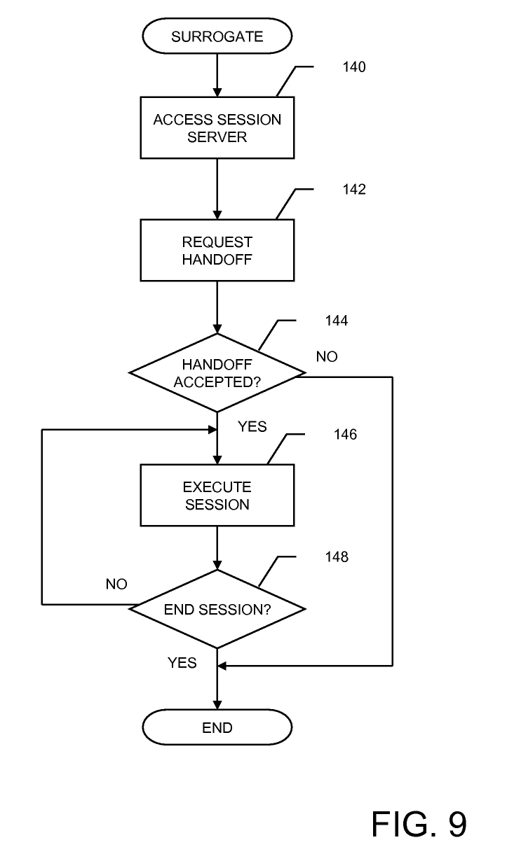

FIG. 9 is a flowchart suitable for programming operation of a surrogate device such as personal computer 40 in relation to the present invention. For example, in step 140 the personal computer 40 connects to the server 32 (102 in FIG. 7). Next, in step 142 the personal computer 40 requests a handoff from MD1 (103 in FIG. 7). In step 144, the personal computer 40 determines if the handoff was accepted. For example, the server 32 may be configured to notify the personal computer 40 that MD1 has authorized the handoff. Alternatively, the personal computer 40 may be configured such that acceptance is assumed, for example, in the absence of an express denial from the server 32 and/or receipt of communications in relation to the ongoing session. If the handoff is accepted as determined in step 144, the personal computer 40 continues to execute the session in step 146 on behalf of MD1. If the handoff is not accepted as determined in step 144, the process ends.

Following step 146, the personal computer 40 in step 148 determines if the user has requested that the session end (e.g., by entering an “end” command). If no, the session continues as a result of the personal computer continuing to loop through steps 146 and 148. If yes in step 148, the personal computer 40 ends the session again using conventional techniques.

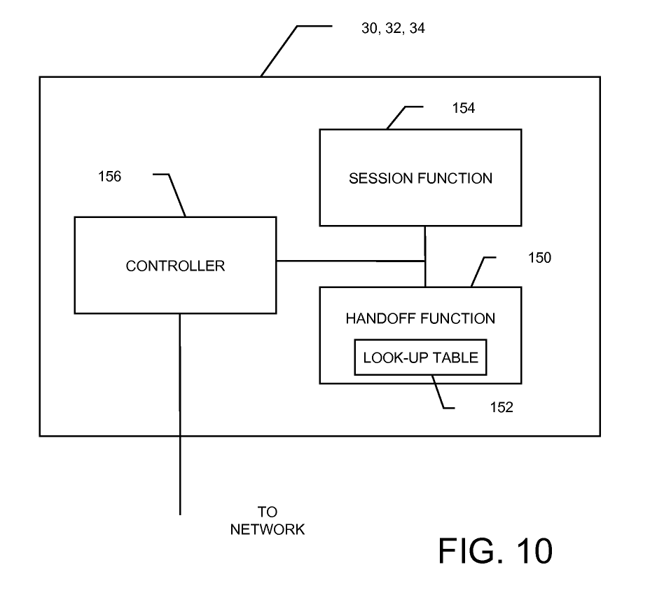

FIG. 10 is a block diagram representing an exemplary configuration of any of the application servers 30, 32, or 34 described herein. As noted above, the servers in the exemplary embodiment include the handoff controller 150 therein, although the handoff controller 150 could instead be located elsewhere within the network so long as the handoff controller can communicate with the server regarding the handoff information to be maintained in the lookup table 152 (as exemplified in FIGS. 4 and 5). The server further include a conventional session function block 154 for carrying out the conventional application functions (e.g., chat session, video over IP session, music session, etc.). Operation of the application session is conventional with the exception that the server redirects communications based on the contents of the handoff lookup table 152 as discussed herein. A general controller 156 is included in the server to interface with the network and to provide overall control.

As will be appreciated, the application servers 30, 32 and 34, handoff controller(s) 150, etc., together with the various other devices (e.g., MD1, MD2, personal computer 40) described herein may each be a computerized apparatus programmed to operate in accordance with the described functions. Those having ordinary skill in the art of computer programming will readily understand how to program a computerized apparatus to carry out the functions described herein without undue effort or experimentation. Accordingly, further detail on the actual programming has been omitted for sake of brevity.

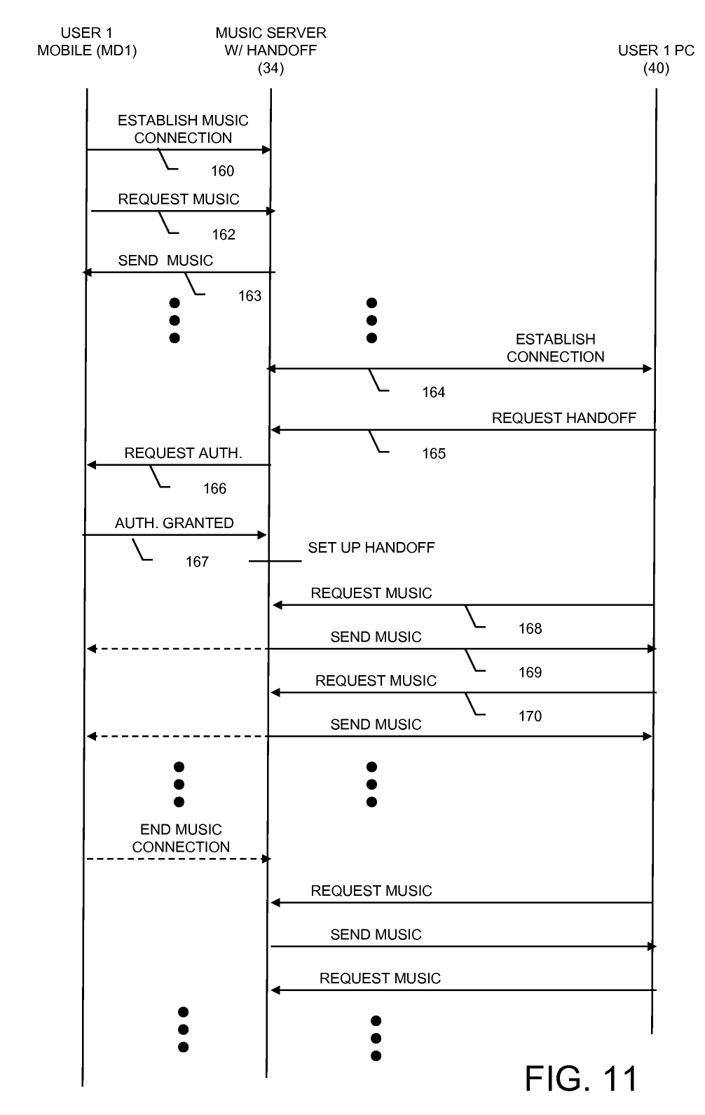

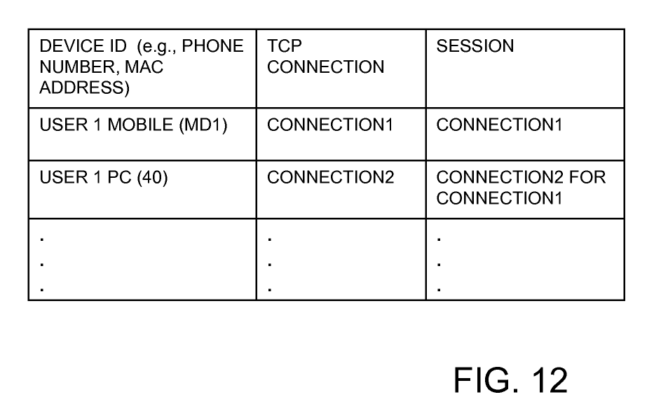

FIGS. 11 and 12 illustrate an application session involving a single mobile device (e.g., MD1) and an application server (e.g., music server 34). In such case, MD1 may connect to the music server 34 in order to stream music from the server 34 to MD1 so that the user of MD1 may listen to the music. Accordingly, MD1 establishes a connection (e.g., Connection 1) with the server 34 (160 in FIG. 11). The handoff controller 150 within the server 34 thus creates an entry in the lookup table 152 as illustrated in FIG. 12. The entry identifies MD1 as being connected to the server 34 via Connection 1, and that MD1 is involved in a music session via a session identifying Connection 1.

MD1 may then proceed to request music to be streamed (162 in FIG. 11), and in turn receive the requested music from the server 34 (163 in FIG. 1 1). Subsequently, a surrogate device such as the user's personal computer 40 may connect to the server 34 and request a handoff with respect to MD1 (164 and 165 in FIG. 11) similar to the above-discussed embodiments. The server 34 in turn requests handoff approval from MD1 (166 and 167 in FIG. 11). Assuming the handoff is approved, the handoff controller 150 updates the lookup table 152 as shown in FIG. 12 to include the personal computer 40 and its corresponding connection (e.g., Connection 2) to the server 34. In addition, the lookup table 152 is updated to include the corresponding session information indicating that the personal computer 40 now serves as a surrogate for MD1 for purposes of receiving the streaming music. Based on the contents of the updated lookup table 152, the server 34 knows to route the session communications to the personal computer 40 in place of MD1 (e.g., 168-170 in FIG. 11). Similarly, the server 34 knows that communications received from the personal computer 40 such as new requests for music are in relation to the same session previously established by MD1.

Thus, it will be appreciate that the present invention provides both an apparatus and method for enabling the user of a mobile device to carry on the functions of the mobile device without the inconvenience of a small or limited user interface. An application session may be taken over from the mobile device by a surrogate device more convenient for purposes of the application (e.g., via a larger display or keyboard, more convenient location, etc.).

The term “mobile device” as referred to herein includes portable radio communication equipment such as mobile phones, pagers, communicators, e.g., electronic organizers, personal digital assistants (PDAs), smartphones or the like.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A hand-off controller for use in a system including an application server, the application server being connected to a mobile device via a first network connection to conduct an application session involving data communications between the application server and the mobile device, the hand-off controller being operatively coupled to the application server and configured to:
recognize that a surrogate device has connected to the application server via a second network connection;
recognize that the surrogate device is intended to participate in the application session in the place of the mobile device;
enable data communications directed to the mobile device from the application server, in relation to the application session, to be sent to the surrogate device; and
enable data communications directed to the application server from the surrogate device, in relation to the application session, to be sent to the application server,
whereby the surrogate device is able to continue the application session with the application server in place of the mobile device.

2. The hand-off controller of claim 1, wherein the hand-off controller is included within the application server.

3. The hand-off controller of claim 1, wherein the surrogate device comprises at least one of a keyboard or display that is larger than a corresponding keyboard or display of the mobile device, and the hand-off controller enables a user to utilize the at least one of a keyboard or display of the surrogate device in place of the corresponding keyboard or display of the mobile device in continuing the application session.

4. The hand-off controller of claim 1, wherein the hand-off controller enables the data communications directed to the mobile device from the application server, in relation to the application session, to be sent to the surrogate device via the second network connection; and enables the data communications directed to the application server from the surrogate device, in relation to the application session, to be sent to the application server via the second network connection.

5. The hand-off controller of claim 4, comprising a look up table that associates the first network connection and the second network connection with the application session.

6. The hand-off controller of claim 1, wherein the data communications sent from the application server to the surrogate device are copied to the mobile device.

7. The hand-off controller of claim 1, wherein the hand-off controller requires user authorization prior to enabling the surrogate device to continue the application session.

8. The hand-off controller of claim 1, wherein the application server is connected to a third party device via a third network connection as part of the application session, the application session involving data communications between the mobile device and the third party device via the application server over the first network connection and the third network connection, and the hand-off controller is configured to:
enable data communications directed to the mobile device from the third party device as received by the application server via the third network connection, in relation to the application session, to be sent to the surrogate device via the second network connection; and
enable data communications directed to the third party device from the surrogate device as received by the application server via the second network connection, in relation to the application session, to be sent to the third party device via the third network connection,
whereby the surrogate device is able to continue the application session with the third party device in place of the mobile device.

9. The hand-off controller of claim 8, wherein the application session comprises a chat session.

10. The hand-off controller of claim 8, wherein the application session comprises video over internet.

11. The hand-off controller of claim 8, comprising a look up table that associates the first network connection, second network connection, and third network connection with the application session.

12. The hand-off controller of claim 8, wherein the data communications sent from the third party device to the surrogate device are copied to the mobile device.

13. The hand-off controller of claim 8, wherein the hand-off controller requires user authorization prior to enabling the surrogate device to continue the application session.

14. A method for handing off communications in a system including an application server, the application server being connected to a mobile device via a first network connection to conduct an application session involving data communications between the application server and the mobile device, the method comprising:
recognizing that a surrogate device has connected to the application server via a second network connection;
recognizing that the surrogate device is intended to participate in the application session in the place of the mobile device;
enabling data communications directed to the mobile device from the application server, in relation to the application session, to be sent to the surrogate device; and
enabling data communications directed to the application server from the surrogate device, in relation to the application session, to be sent to the application server,
whereby the surrogate device is able to continue the application session with the application server in place of the mobile device.

15. The method of claim 14, wherein the method is carried out within the application server.

16. The method of claim 14, wherein the surrogate device comprises at least one of a keyboard or display that is larger than a corresponding keyboard or display of the mobile device, and the method is carried out to enable a user to utilize the at least one of a keyboard or display of the surrogate device in place of the corresponding keyboard or display of the mobile device in continuing the application session.

17. The method of claim 14, wherein the data communications directed to the mobile device from the application server, in relation to the application session, are sent to the surrogate device via the second network connection; and the data communications directed to the application server from the surrogate device, in relation to the application session, are sent to the application server via the second network connection.

18. The method of claim 17, comprising using a look up table that associates the first network connection and the second network connection with the application session.

19. The method of claim 14, wherein the data communications sent from the application server to the surrogate device are copied to the mobile device.

20. The method of claim 14, comprising requiring user authorization prior to enabling the surrogate device to continue the application session.

21. The method of claim 14, wherein the application server is connected to a third party device via a third network connection as part of the application session, the application session involving data communications between the mobile device and the third party device via the application server over the first network connection and the third network connection, and:
enabling data communications directed to the mobile device from the third party device as received by the application server via the third network connection, in relation to the application session, to be sent to the surrogate device via the second network connection; and
enabling data communications directed to the third party device from the surrogate device as received by the application server via the second network connection, in relation to the application session, to be sent to the third party device via the third network connection,
whereby the surrogate device is able to continue the application session with the third party device in place of the mobile device.

22. The method of claim 21, wherein the application session comprises a chat session.

23. The method of claim 21, wherein the application session comprises video over internet.

24. The method of claim 21, wherein the application session comprises voice over internet.

25. The method of claim 21, comprising using a look up table that associates the first network connection, second network connection, and third network connection with the application session.

26. The method of claim 21, wherein the data communications sent from the third party device to the surrogate device are copied to the mobile device.

27. The method of claim 21, comprising requiring user authorization prior to enabling the surrogate device to continue the application session.
